(19) United States
(12) Patent Application Publication
(10) Pub. No.: US 2024/0416379 A1
(43) Pub. Date: Dec. 19, 2024

(54) LIQUID SPRAY DEVICE WITH REARWARD ATOMIZATION INHIBITION

(71) Applicant: Vida International Inc., Taipei City (TW)

(72) Inventors: Zhi-Kai Xu, Montclair, CA (US); Bing-Xin Zhu, Taipei Hsien (TW)

(21) Appl. No.: 18/738,889

(22) Filed: Jun. 10, 2024

(30) Foreign Application Priority Data
Jun. 15, 2023 (TW) 112206126

(51) Int. Cl. B05B 17/06

(52) U.S. Cl. CPC B05B 17/0615; B05B 17/0669; B05B 17/0684

(57) ABSTRACT

A spray unit with a spray device is disclosed. The spray unit includes a movable bracket, a vibrating element, and a liquid-absorbing sheet. The vibrating element includes a vibratable sheet fixed to the bracket, which can produce high-frequency vibrations when electrified. The liquid-absorbing sheet may be made of non-woven fabric or cotton pad, and is attached to the back of the vibrating element for absorbing liquid. By placing the bracket movably within a spray device, a spray device equipped with a spray unit is formed. The bracket allows the liquid-absorbing sheet on the back of the vibrating element to press against the wick end of a liquid bottle, preventing the vibrating element from spraying towards the inside of the spray device and preventing liquid dripping inside the spray device.

### CROSS-REFERENCE TO RELATED APPLICATION

This application claims priority from Taiwanese Patent Application No. TW M645454 filed Jun. 15, 2023, which is incorporated herein by reference.

### FIELD OF THE INVENTION

The present invention relates to ultrasonic vibration atomization, specifically to an atomizing unit and an atomizing device equipped with said unit.

### BACKGROUND INFORMATION

FIGS. 1, 2 and 3 illustrate a known ultrasonic vibration atomizing device comprising a shell 100, a control unit 200, an atomizing unit 300, and a liquid bottle 400. The shell 100 has a base 101 and a cover 102, with the cover 102 featuring an atomizing window 103. The control unit 200 is fixed to the front of the base 101 and is used to set and control the atomization cycle and volume. The atomizing unit 300 consists of a bracket 301 and a vibratory element 302. One end of the bracket 301 is rotatably attached to the control unit 200 or another location, while the other end holds the vibratory element 302. The bracket 301 allows the back of the vibratory element 302 to press against the wick end 401 of the liquid bottle 400. The vibratory element 302 is electrically connected to the control unit 200 via wires or other conductive means. As such, the control unit 200 can control the vibratory element 302 to produce high-frequency vibrations, atomizing the liquid from the wick 401 and directing it towards the atomizing window 103 of the cover 102.

In the aforementioned ultrasonic vibration atomizing device, because the back of the vibratory element 302 directly presses against the wick end 401 of the liquid bottle 400 (as shown in FIGS. 2 and 3), not all of the produced mist is directed towards the atomizing window 103. Some of the mist sprays inward onto the liquid bottle 400. When the inwardly sprayed mist accumulates on the exterior of the liquid bottle 400 to a certain extent, it results in liquid dripping from the bottom of the atomizing device. Addressing and overcoming this internal misting and liquid dripping issue is a primary challenge of this invention.

### SUMMARY OF THE INVENTION

The present invention provides an atomizing unit and an atomizing device equipped with said unit. Through structural improvements in the atomizing unit, which includes a liquid-absorbing sheet, the invention aims to prevent misting towards the interior of the atomizing device and to prevent liquid dripping within the device.

A secondary objective of this invention is to provide an atomizing unit and an atomizing device equipped with said unit. Through the design of the bracket in the atomizing unit, the invention achieves the benefits of easy fixation and replacement of the liquid-absorbing sheet.

To achieve the aforementioned objectives, this invention proposes an atomizing unit. Its optimal technical solution includes: a bracket, a vibratory element, and a liquid-absorbing sheet. The bracket is a movable component. The vibratory element, fixed to the bracket, is a metal sheet that can produce high-frequency vibrations when electrified. The liquid-absorbing sheet, made of non-woven fabric or cotton, is attached to the back of the vibratory element. The bracket ensures that the liquid-absorbing sheet on the back of the vibratory element presses against the wick end of a liquid bottle.

In the aforementioned atomizing unit, the bracket has two parallel swing arms spaced apart and a crossbar connecting the two swing arms. The crossbar has a nozzle connecting its front and back. The vibratory element and the liquid-absorbing sheet are positioned on the back or inside of the crossbar and block the nozzle. The crossbar holds the liquid-absorbing sheet in place, ensuring it adheres to the back of the vibratory element.

In the aforementioned atomizing unit, the bracket includes a fixed component. This fixed component is attached to the bracket and presses the liquid-absorbing sheet against the back of the vibratory element.

In the aforementioned atomizing unit, the back of the bracket features a cavity. The vibratory element and the liquid-absorbing sheet are sequentially fixed within this cavity, and the fixed component is then attached to the cavity.

In the aforementioned atomizing unit, the fixed component has two pressure strips. These strips press against the near edges of the back of the liquid-absorbing sheet, ensuring the front center of the sheet adheres to the back of the vibratory element.

To achieve the aforementioned objectives, this invention proposes an atomizing device equipped with the atomizing unit. It comprises: a shell, a control unit, a liquid bottle, and the aforementioned bracket, vibratory element, and liquid-absorbing sheet that make up the atomizing unit. The shell has a base and a cover attached to the front of the base. The cover features an atomizing port that connects to the interior. The control unit is positioned at the front of the base and controls the high-frequency vibrations of the vibratory element. The liquid bottle is placed below the control unit, with its bottle neck extending a wick. One end of the bracket is attached to the control unit or the shell, ensuring the liquid-absorbing sheet on the back of the vibratory element presses against the wick end of the liquid bottle.

This invention's atomizing unit and atomizing device equipped with said unit, through the aforementioned addition of a liquid-absorbing sheet to the back of the vibratory element, ensures that the sheet presses against the wick end of the liquid bottle. Utilizing the liquid-absorbing properties of the sheet, the invention effectively prevents misting towards the interior of the atomizing device and liquid dripping within the device. Additionally, through the design of the bracket, the invention facilitates easy fixation and replacement of the liquid-absorbing sheet.

An aspect of the present invention is to provide an atomizing unit for installation in an atomizing device, comprising a movable bracket, a vibratory element on the movable bracket comprising a vibratable sheet structured and arranged to produce high-frequency vibrations when electrified, and a liquid-absorbing sheet on a back of the vibratory element structured and arranged to contact a wick of the atomizing device when the atomizing unit is installed in the atomizing device.

Another aspect of the present invention is to provide an atomizing device equipped with an atomizing unit, comprising a shell, a control unit and a liquid bottle. The atomizing unit comprises a movable bracket, a vibratory element on the movable bracket comprising a vibratable sheet structured and arranged to produce high-frequency vibrations when electrified, and a liquid-absorbing sheet on a back of the vibratory element structured and arranged to contact a wick of the atomizing device when the atomizing unit is installed in the atomizing device.

These and other aspects of the present invention will be more apparent from the following description.

### BRIEF DESCRIPTION OF THE DRAWINGS

FIG. 1 is a partial exploded view of a known atomizing device.

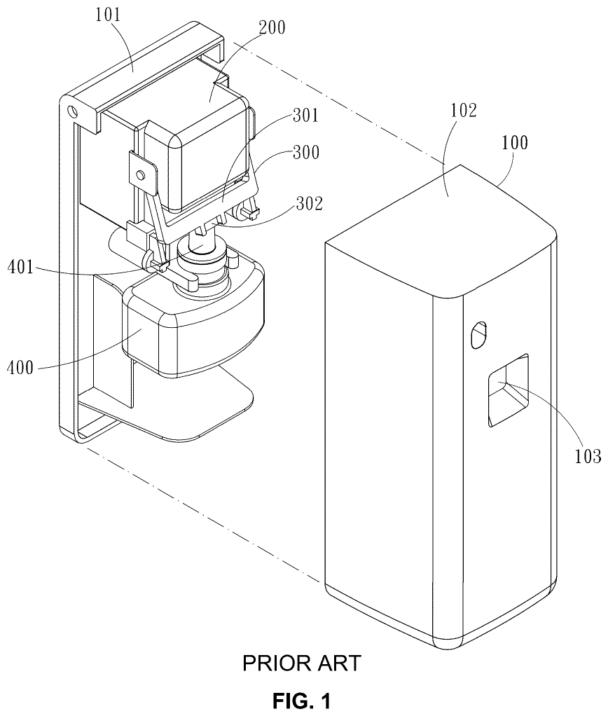

FIG. 2 is cross-sectional view of a known atomizing device.

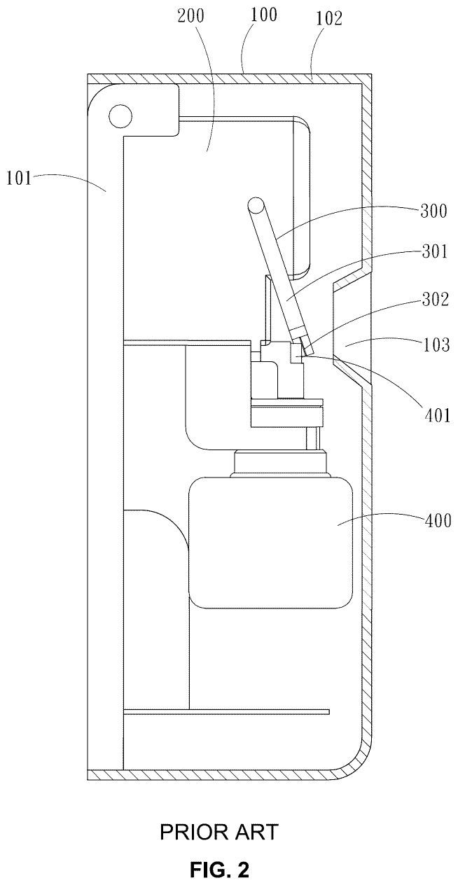

FIG. 3 depicts the contact method between the known atomizing unit and the liquid bottle.

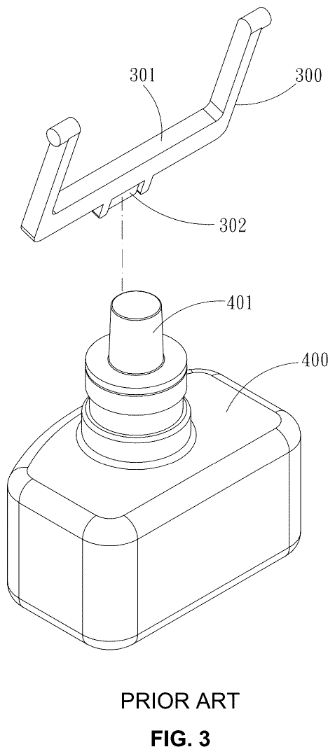

FIG. 4 is a front isometric view of the atomizing unit of this invention.

FIG. 5 is rear isometric view of the atomizing unit of this invention.

FIG. 6 is an exploded isometric view of the atomizing unit of this invention.

FIG. 7 is a partial exploded isometric view of the atomizing device equipped with the atomizing unit of this invention.

### DETAILED DESCRIPTION

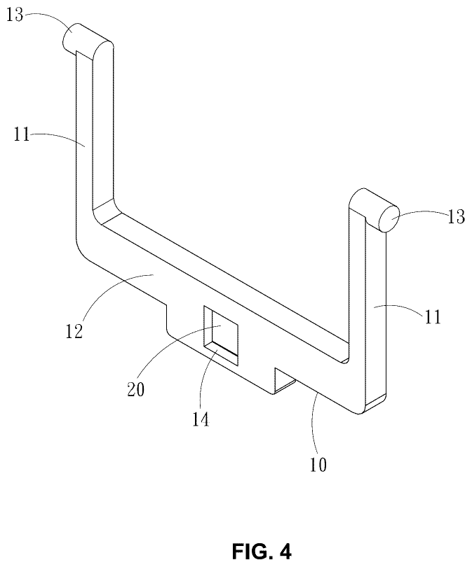

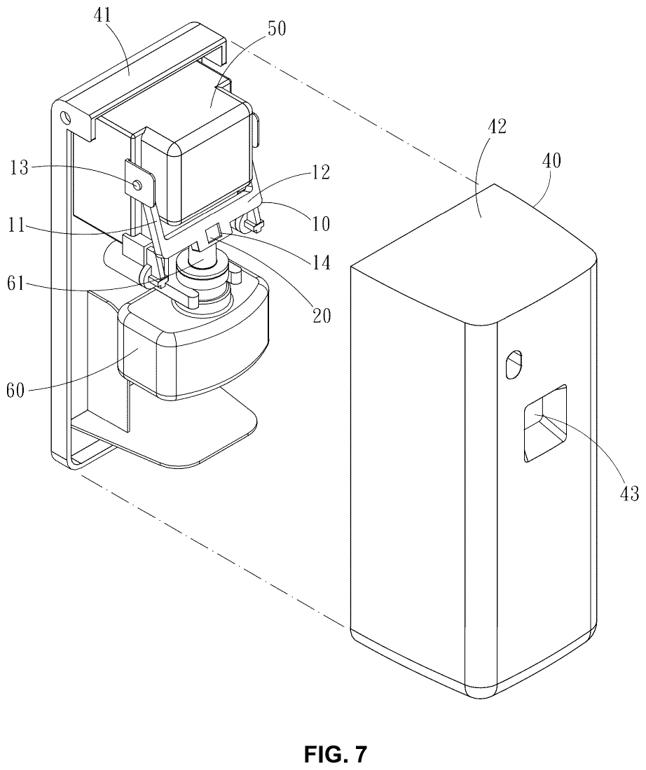

Referring to FIGS. 4 to 6, the atomizing unit of this invention is designed to be installed in an atomizing device (as shown in FIG. 7), atomizing liquid into mist and spraying it out of the device. It can be used to spray mists such as perfume and alcohol. A preferred embodiment includes: a bracket 10, a vibratory element 20, and a liquid-absorbing sheet 30. The bracket 10 is a movable component installed in the atomizing device. The vibratory element 20, fixed to the bracket 10, may be a metal sheet that produces high-frequency vibrations when electrified. The liquid-absorbing sheet 30, which may be made of non-woven fabric or cotton, adheres to the back of the vibratory element 20. As shown in FIG. 7, when the atomizing unit of this invention is in use, the bracket 10 allows the back of the vibratory element 20, with the liquid-absorbing sheet 30, to press against the wick end 61 of a liquid bottle 60. Using the liquid-absorbing properties of the sheet 30, the vibratory element 20, when electrified and vibrating, can prevent misting towards the interior of the atomizing device and also prevent liquid from dripping within the device.

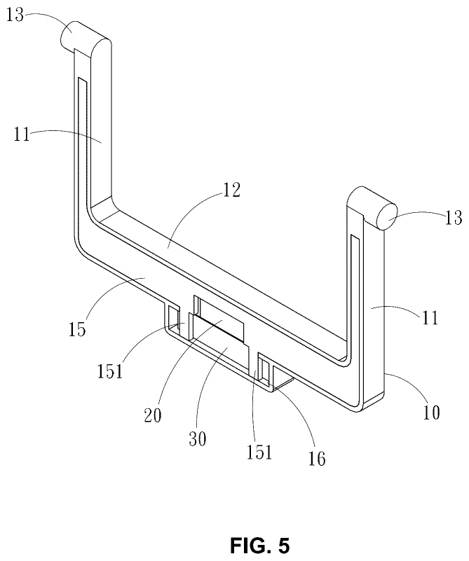

As shown in FIGS. 4 and 5, in a more specific embodiment of the aforementioned atomizing unit, the bracket 10 has two parallel swing arms 11 spaced apart and a crossbar 12 connecting them, forming a U-shape. The upper ends of the two swing arms 11 each have a pivot part 13. The crossbar 12 has a nozzle 14 connecting its front and back. The vibratory element 20 and the liquid-absorbing sheet 30 are positioned on the back or inside of the crossbar 12 and block the nozzle 14. The crossbar 12 holds the liquid-absorbing sheet 30 in place, ensuring it adheres to the back of the vibratory element 20.

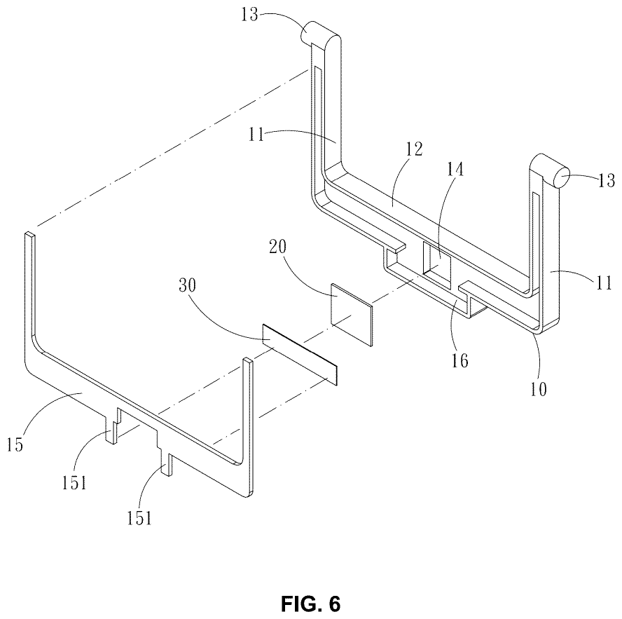

As shown in FIG. 6, to facilitate the fixation and replacement of the liquid-absorbing sheet 30, the back of the bracket 10 of this invention can have a fixed component 15. This fixed component 15 is attached to the back of the bracket 10, pressing the liquid-absorbing sheet 30 against the back of the vibratory element 20. More specifically, the back of the bracket 10 can have a cavity 16. The vibratory element 20 and the liquid-absorbing sheet 30 are sequentially fixed within this cavity 16, and then the fixed component 15 is attached to the cavity 16, forming a structure where the fixed component 15, when combined with the cavity 16, also holds the liquid-absorbing sheet 30 in place. The fixed component 15 can have two pressure strips 151 that press against the near edges of the back of the liquid-absorbing sheet 30, ensuring the front center of the sheet adheres to the back of the vibratory element 20.

Referring to FIG. 7, based on the technical features of the aforementioned atomizing unit, this invention further proposes an atomizing device equipped with the atomizing unit. The atomizing device includes: the aforementioned bracket 10, vibratory element 20, and liquid-absorbing sheet 30 that make up the atomizing unit, along with a shell 40, a control unit 50, and a liquid bottle 60. The shell 40 has a base 41 and a cover 42 attached to the front of the base. The cover 42 features an atomizing port 43 that connects to the interior. The control unit 50 is positioned at the front of the base 41 and is electrically connected to the vibratory element 20, controlling its high-frequency vibrations. The liquid bottle 60 is placed below the control unit 50, with its bottle neck extending a wick 61. The two swing arms 11 of the bracket 10 are attached to the control unit 50 or the shell 40, allowing the back of the vibratory element 20, with the liquid-absorbing sheet 30, to press against the wick end 61 of the liquid bottle 60, achieving the effects of preventing misting towards the interior of the atomizing device and preventing liquid from dripping within the device.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. An atomizing unit for installation in an atomizing device, comprising:
a movable bracket;
a vibratory element on the movable bracket comprising a vibratable sheet structured and arranged to produce high-frequency vibrations when electrified; and
a liquid-absorbing sheet on a back of the vibratory element structured and arranged to contact a wick of the atomizing device when the atomizing unit is installed in the atomizing device.

2. The atomizing unit of claim 1, wherein the vibratable sheet comprises metal.

3. The atomizing unit of claim 1, wherein the liquid-absorbing sheet comprises non-woven fabric.

4. The atomizing unit of claim 1, wherein the liquid-absorbing sheet comprises cotton.

5. The atomizing unit of claim 1, wherein the bracket comprises two parallel swing arms spaced apart and connected by a crossbar connecting them, wherein the crossbar comprises a nozzle extending through front and back surfaces of the crossbar, the vibratory element and the liquid-absorbing sheet are positioned on the back or inside of the crossbar and at least partially block the nozzle, and the crossbar holds the liquid-absorbing sheet in place against the back of the vibratory element.

6. The atomizing unit of claim 5, wherein the bracket comprises a fixed component attached to the bracket pressing the liquid-absorbing sheet against the back of the vibratory element.

7. The atomizing unit of claim 6, wherein a back of the bracket comprises a cavity, the vibratory element and the liquid-absorbing sheet are sequentially fixed within the cavity, and the fixed component is attached to the cavity.

8. The atomizing unit of claim 7, wherein the fixed component comprises two pressure strips pressing against edges of a back of the liquid-absorbing sheet and a front center of the sheet adheres to the back of the vibratory element.

9. An atomizing device equipped with an atomizing unit, comprising a shell, a control unit and a liquid bottle, wherein the atomizing unit comprises:
a movable bracket;
a vibratory element on the movable bracket comprising a vibratable sheet structured and arranged to produce high-frequency vibrations when electrified; and
a liquid-absorbing sheet on a back of the vibratory element structured and arranged to contact a wick of the atomizing device when the atomizing unit is installed in the atomizing device.

10. The atomizing device of claim 9, wherein the shell comprises a base and a cover attached to a front of the base comprising an atomizing port in fluid communication with the liquid bottle.

11. The atomizing device of claim 10, wherein the control unit is positioned at the front of the base and controls high-frequency vibrations of the vibratory element, the liquid bottle is located below the control unit and comprises a bottle neck with the wick extending therefrom, and one end of the bracket is attached to the control unit or the shell to allow the back of the vibratory element, with the liquid-absorbing sheet, to press against the wick.
